(19) United States
(12) Patent Application Publication
(10) Pub. No.: US 2025/0136142 A1
(43) Pub. Date: May 1, 2025

(54) TRAFFIC LIGHT DETECTION THROUGH PROMPTING

(71) Applicant: GM Cruise Holdings LLC, San Francisco, CA (US)

(72) Inventors: Amirreza Shaban, Bellevue, WA (US); Ankit Raj, Santa Clara, CA (US); Sachithra Hemachandra, Sunnyvale, CA (US)

(21) Appl. No.: 18/494,698

(22) Filed: Oct. 25, 2023

(51) Int. Cl. B60W 60/00; G01C 21/36; G06T 7/73; G06V 20/58

(52) U.S. Cl. CPC B60W 60/001; G01C 21/3602; G06T 7/74; G06V 20/584; B60W 2420/403; B60W 2552/00; B60W 2555/60; G06T 2207/30252

(57) ABSTRACT

Systems, methods, and non-transitory computer readable mediums are provided for detecting traffic lights in images based on prompts that automatically limit the search space within the images for the traffic lights. For example, a system may receive image data and prompt data identifying a search space for traffic light detection. Additionally, the system may generate layout data based on the prompt data and generate traffic light data based on the image data and the layout data. Moreover, the system may determine state information for one or more first traffics included in the image data based on the traffic light data. Further, the system may implement one or more operations associated with a navigation and routing system of the autonomous vehicle based on the state information.

### BACKGROUND

### 1. Technical Field

The present disclosure generally relates to object detection in one or more images and, more specifically, the utilization of prompts to limit the areas of interest in the one or more images for object detection.

### 2. Introduction

An autonomous vehicle (AV) is a motorized vehicle that can navigate without a human driver. An exemplary AV can include various sensors, such as a camera sensor, a light detection and ranging (LIDAR) sensor, and a radio detection and ranging (RADAR) sensor, amongst others. The sensors collect data and measurements that the AV can use for operations such as navigation. The sensors can provide the data and measurements to an internal computing system of the AV, which can use the data and measurements to control a mechanical system of the AV, such as a vehicle propulsion system, a braking system, or a steering system. Additionally, data generated by the sensors may be utilized to identify and determine one or more objects in an environment around the AV.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates an exemplary computing environment that can be used to facilitate object detection based on prompts, according to some aspects of the disclosed technology;

FIGS. 2-4 illustrate diagrams of portions of the exemplary computing environment, according to some examples of the present disclosure;

FIG. 5 illustrates a flowchart of an exemplary process for utilizing a prompt for facilitating object detection, according to some examples of the present disclosure;

FIG. 6 illustrates an example of a deep learning neural network, according to some aspects of the disclosed technology; and

FIG. 7 illustrates an example processor-based system with which some aspects of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form to avoid obscuring the concepts of the subject technology.

Some aspects of the present technology may relate to the gathering and use of data available from various sources to improve safety, quality, and experience. The present disclosure contemplates that in some instances, this gathered data may include personal information. The present disclosure contemplates that the entities involved with such personal information respect and value privacy policies and practices.

In some examples, one or more autonomous vehicles (e.g., AVs) and/or data centers managing the one or more autonomous vehicles, may utilize traffic light detection systems to detect and identify traffic lights that the one or more AVs encounter. The traffic light detection system may determine the state of various traffic lights (e.g., whether the lights are green/red), as well as which lights are relevant to the AVs navigation. In some AV deployments, the traffic light detection system may heavily rely on high-resolution or high-definition (HD) maps to detect and identify traffic lights the AVs encounter and determine the state of each of the traffic lights that the one or more AVs detect and identify. Further, the traffic light detection system may focus on a small region of interest within the HD maps to detect and determine the state of each of the traffic lights. For instance, the traffic light detection system may focus on portions of the HD map that correspond to each lighting element, such as a bulb, in each traffic light that the one or more AVs encounter.

However, such heavy reliance on the HD maps may be costly and computing-resource intensive when acquiring and maintaining such HD maps. Additionally, the traffic light detection system may not be robust or adaptive to changes that may occur with the traffic lights in the actual environment the AV is in. For instance, a traffic light may be added, moved a few feet from the location indicated in the HD maps or oriented differently as indicated in the HD maps. Further, the traffic light detection system may require manual tuning of parameters specific to each area, such as a city, the traffic light detection system is applied to. As such, the traffic light detection system may be less scalable as the traffic light detection system is applied to new locations.

As described herein, a computing system, such as a traffic light detection system, may detect traffic lights in images captured by one or more processors of an AV. For instance, the computing system may utilize one or more machine learning or artificial intelligence processes, such as convolutional neural network type processes, to detect the traffic lights in the captured. Additionally, the one or more machine learning or artificial intelligence processes may be fully data driven and adaptable. Further, the computing system may utilize prompts to automatically limit the search space within the captured images for the traffic lights. As such, the prompt may indicate to the computing system portions of the captured images to focus on and portions of the captured images to ignore when identifying or detecting one or more traffic lights in the captured images.

In some examples, the prompt may include one or more portions of a HD map that are relevant to the captured images. As described herein, one or more portions of the HD map may include location information. In some instances, the location information may correspond to an area, location or environment the images were captured in. Additionally, the one or more portions of the HD map may include information of one or more traffic lights that may have been included in the captured images. In some instances, the one or more portions of the HD map may identify the one or more traffic lights and may characterize one or more attributes of the one or more traffic lights. Examples of such attributes include a location of a corresponding traffic light, an orientation of the corresponding traffic light, a size of the corresponding traffic light, a shape of the corresponding traffic light, number of bulbs of the corresponding traffic light, and a size of each of the bulbs of the corresponding traffic light and a shape of each of the bulbs of the corresponding traffic light.

Additionally, the prompt may include rough location information of traffic lights that may be captured in the image. In some instances, the prompt may include orientation of each traffic light. Additionally, or alternatively, the prompt may indicate a primary traffic light of interest (herein described as the primary traffic light) for the AV. As described herein, the primary traffic light of interest or the primary traffic light for the AV is the traffic light that affects one or more operations that the AV may perform, such as the movement of the AV. As such, the prompt may enable the computing system to maintain high precision traffic light detection and traffic light state determination while relying less on the HD maps. Further, the computing system may be more adaptable to changes in the environment and reduce the need for manual parameter tuning when applied to different cities.

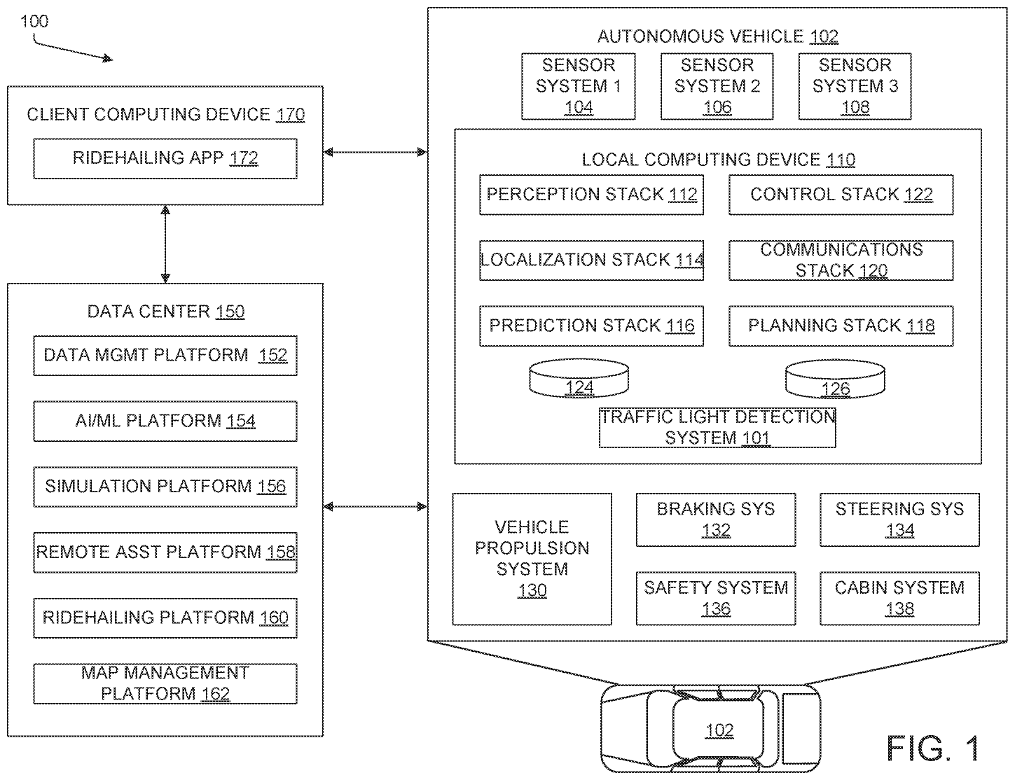

FIG. 1 is a diagram illustrating an example autonomous vehicle (AV) environment 100, according to some examples of the present disclosure. One of ordinary skill in the art will understand that, for AV environment 100 and any system discussed in the present disclosure, there can be additional or fewer components in similar or alternative configurations. The illustrations and examples provided in the present disclosure are for conciseness and clarity. Other examples may include different numbers and/or types of elements, but one of ordinary skill the art will appreciate that such variations do not depart from the scope of the present disclosure.

As illustrated in FIG. 1, the AV environment 100 includes an AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

As described herein, AV 102 may include traffic light detection system 101 that utilizes one or more machine learning or artificial intelligence processes, such as convolutional neural network type processes, to detect one or more objects in images captured by one or more sensors of AV 102. Additionally, traffic light detection system 101 may determine whether the detected objects are traffic lights based on prompts as described herein. Further, the prompts may indicate the search space or portions of the captured images that traffic light detection system 101 is to focus on. As such, traffic light detection system 101 may determine whether objects detected in the indicated search space or portions of the captured image are traffic lights. Further, traffic light detection system 101 may ignore the other portions of the captured images.

In some examples, traffic light detection system 101 may obtain and process images captured by one or more sensors of AV 102. Additionally, the prompt may indicate a traffic light search space or portions of the processed images traffic light detection system 101 should focus on when identifying one or more traffic lights. As illustrated in FIG. 1, AV 102 may include multiple sensor systems 104, 106, and 108. The sensor systems 104, 106, and 108 can include one or more types of sensors and can be arranged about the AV 102. In such examples, one or more of sensor systems 104, 106, 108 may be a camera system. Additionally, one or more sensors of the one or more camera systems may capture one or more images of an environment that AV 102 is in. As described herein, the environment captured in the one or more images may include one or more traffic lights. Additionally, the one or more sensors may generate image data that includes the one or more images.

Further, traffic light detection system 101 may utilize one or more trained artificial intelligence or machine learning (AI/ML) processes to process the one or more images of the image data. Examples of one or more trained AI/ML processes that are associated with object detection within one or more images includes a convolutional neural network type model (e.g., region-based convolutional neural networks (R-CNN)), fast R-CNN, and you only look once (YOLO) and a detection transformer end-to-end object detection type (e.g., DETR). The trained AI/ML process, when applied to the one or more images may detect or identify one or more objects within the one or more images. Based on the application of the trained AI/ML process to the one or more images, traffic light detection system 101 may generate processed image data that identifies the one or more objects detected in the one or more images and corresponding portions of the one or more images that correspond to each of the one or more detected objects. In some instances, traffic light detection system 101 may include the one or more images within the processed image data.

In other examples, traffic light detection system 101 may obtain and/or generate a prompt that indicates where in the one or more images of the processed image data to search for or determine the presence of one or more traffic lights. In some instances, the prompt may include one or more portions of HD map data that are relevant to the captured images. In other instances, the prompt may be one or more portions of the HD map data that are relevant to the captured images. As described herein, a HD map data may include a set of data points in a three-dimensional coordinate system and the set of data points of the HD map data may be a diagrammatic representation of an area. Additionally, each data point of the set of data points may represent a single spatial measurement on the surface of an object included in the corresponding area, such as a traffic light. Further, additional data may be included in the HD map data that may characterize one or more attributes of objects included in the corresponding area (e.g., a type of traffic light, a location of a corresponding traffic light, an orientation of the corresponding traffic light, a size of the corresponding traffic light, a shape of the corresponding traffic light, number of bulbs of the corresponding traffic light, and a size of each of the bulbs of the corresponding traffic light and a shape of each of the bulbs of the corresponding traffic light).

Additionally, the one or more portions of the HD map data may correspond to an area or location the one or more images were captured in, or an area or location of the environment captured in the one or more images. In some examples, traffic light detection system 101 may receive location information and/or pose information associated with the one or more images captured by one or more sensors of AV 102. In such examples, traffic light detection system 101 may receive, from localization stack 114, location data indicating a location and/or pose of AV 102. As described herein, the location of AV 102 may be a current location of AV 102 and the current location may be where the one or more images were captured by the one or more sensors of AV 102. Further, the pose of AV 102 may be the position and orientation of AV 102 and may indicate a direction where the front of AV 102 was facing when the one or more images were captured by the one or more sensors of AV 102 and the field of view of each of the one or more sensors of AV 102.

In other examples, such location information and/or pose information may be included in the image data. In such examples, when the one or more images of the image data were generated by the one or more sensors of AV 102, localization stack 114 may generate location data associated with the one or more images. Additionally, traffic light detection system 101 may receive, from localization stack 114, the location data and may associate one or more portions of the location data with one or more portions of image data.

Moreover, based on the obtained location data of AV 102, traffic light detection system 101 may obtain one or more portions of HD map data associated with the location and/or pose of AV 102. For example, traffic light detection system 101 may access HD geospatial database 126. Based on the obtained location data, traffic light detection system 101 may obtain one or more portions of HD map data stored in HD geospatial database 126 associated with the location and/or pose of AV 102. The one or more portions of HD map data obtained from HD geospatial database 126 may include a set of data points that are a diagrammatic representation of an area that was captured in the one or more images of the image data. As described herein, the area captured in the one or more images may correspond to the location or pose of AV 102 as indicated by the obtained location data. Further, the one or more portions of the HD map may include information of one or more traffic lights that may have been included in the one or more images of the image data (e.g., a type of traffic light, a location of a corresponding traffic light, an orientation of the corresponding traffic light, a size of the corresponding traffic light, a shape of the corresponding traffic light, number of bulbs of the corresponding traffic light, and a size of each of the bulbs of the corresponding traffic light and a shape of each of the bulbs of the corresponding traffic light). In some instances, the obtained one or more portions of HD map data may include rough location information of traffic lights that may be captured in the image. In other instances, the obtained one or more portions of HD map data may include orientation information of traffic lights that may be captured in the image. In various instances, the one or more portions of HD map data may indicate that there are several side-by-side traffic lights and one or more single traffic lights in the area that was captured in the one or more images of the image data. In such instances, traffic light detection system 101 may obtain rough location information for the single traffic lights and obtain rough location information and orientation information of each of the side-by-side traffic lights. As such, the one or more portions of HD map data may include rough location and orientation information of each of the side-by-side traffic lights and rough location information for the single traffic lights.

Additionally, the prompt may identify, in the one or more portions of the HP map data, a primary traffic light of interest (herein described as the primary traffic light) for AV 102. Moreover, traffic light detection system 101 may identify the primary traffic light in one or more images of the image data based on the primary traffic light identified in the prompt. In some examples, the primary traffic light of interest for AV 102 may be based in part on pose of AV 102 and/or decision information of AV 102. As described herein, the decision information may characterize one or a set of operations that AV 102 may perform and traffic light detection system 101 may obtain decision information from planning stack 118.

For example, planning stack 118 may determine the one or set of operations that AV 102 may perform based in part on the location and pose of AV 102, as indicated by the location data as described herein. Additionally, based on the data points of the one or more obtained portions of HD map data, traffic light detection system 101 may determine whether any traffic lights are included in the one or more obtained portions of HD map. In examples where traffic light detection system 101 determines one or more traffic lights are included in the one or more obtained portions of HD map data, traffic light detection system 101 may determine whether the one or more traffic lights are facing AV 102. In such examples traffic light detection system 101 may utilize location data generated by localization stack 114 and the data points that are associated with each of the one or more traffic lights and associated attributes to determine whether the one or more traffic lights are facing AV 102. As described herein the location data may indicate the location and pose of AV 102.

Additionally, when traffic light detection system 101 determines one or more traffic lights are facing AV 102, traffic light detection system 101 may determine whether a particular one of the one or more traffic lights that are facing AV 102 would affect the operation of AV 102. Moreover, traffic light detection system 101 may determine whether a particular one of the one or more traffic lights that are facing AV 102 would affect the operation of AV 102 based on one or more attributes of each of the one or more traffic lights (e.g., shape of the lighting element and/or the state of the lighting element (e.g., the color of the lighting element), and the decision information, traffic light detection system 101.

By way of example, based on a location of AV 102, one or more associated portions of HD map data may indicate that there are two traffic lights facing AV 102. Additionally, traffic light detection system 101 may identify the two traffic lights based on the data points of the one or more portions of HD map. Moreover, based on the location data and the one or more portions of HD map data (the data points that are associated with each of the two traffic lights and corresponding attributes), traffic light detection system 101 may determine whether each of the two traffic lights are facing the front of AV 102, such as the lighting elements of each of the two traffic lights are facing the front of AV 102. In examples where traffic light detection system 101 determines the two traffic lights are facing the front of AV 102, traffic light detection system 101 may further determine whether one or both of the traffic lights would affect the operation of AV 102. For instance, based on the decision information, traffic light detection system 101 may determine that the set of operations of the decision information indicate that AV 102 is to turn left. Additionally, based on the one or more attributes of each of the two traffic lights, traffic light detection system 101 may determine one of the two traffic lights includes a lighting element that illuminates an arrow pointing left, while the lighting elements of the other traffic light each illuminate a circle. As such, traffic light detection system 101 may determine that the traffic light that includes a lighting element that illuminates the arrow pointing left is the primary traffic light of interest. Additionally, traffic light detection system 101 may generate data identifying the traffic light with the lighting element that illuminates the arrow pointing left is the primary traffic light. In some instances, traffic light detection system 101 may include, within one or more portions of the prompt, the data identifying the traffic light with the lighting element that illuminates the arrow pointing left as the primary traffic light.

Alternatively, based on the decision information, traffic light detection system 101 may determine that the set of operations of the decision information indicate that AV 102 is to continue driving straight. Additionally, based on the on one or more attributes of each of the two traffic lights, traffic light detection system 101 may both traffic lights include lighting elements that each illuminate a corresponding circle. Further, based on the on one or more attributes of each of the two traffic lights and the decision information, traffic light detection system 101 may determine that neither traffic like is the primary traffic light of interest. In such an instance, the prompt may not indicate which traffic light in the one or more portions of HD map data is the primary traffic light.

Referring back to FIG. 1, traffic light detection system 101 may generate, based on the prompt and the processed image data, traffic light data. As described herein, the traffic light data may identify one or more traffic lights within one or more images of the processed image data, and corresponding portions of the one or more images of each of the one or more identified traffic lights. Additionally, the traffic light data may identify one or more lighting elements of each of the one or more traffic lights identified within the one or more images, and portions of the one or more images that correspond to the identified one or more lighting elements. Moreover, the traffic light data may indicate a state of each of the one or more identified lighting elements, such as the color of the lighting element and whether the lighting element illuminated. Further, the traffic light data may indicate which of the one or more traffic lights identified within the one or more images is the primary traffic light.

In some examples, traffic light detection system 101 may employ a cross-transformer decoder architecture including a first transformer and a second transformer. Additionally, the first transformer and the second transformer, combined, may generate the traffic light data. For example, the first transformer of traffic light detection system 101 may generate layout data based on the one or more portions of HD map data included in the prompt. As described herein, the layout data may identify each of the traffic lights identified in the one or more portions of HD map data included in the prompt, corresponding attributes and the relational attributes between each of the traffic lights identified in the one or more portions of HD map data (e.g., spatial relationships between each of the traffic lights, orientation of each of the identified traffic lights with respect to one another, and location/position of each of the identified traffic lights with respect to one another). Additionally, the layout data may include or identify portions of the HD map data that correspond to each of the traffic lights identified in the one or more portions of map data included in the prompt. Moreover, the layout data may indicate which portions of the one or more portions of HD map data are associated with each of the identified traffic lights. Further, based on the prompt, the layout data may indicate which of the identified traffic lights is the primary traffic light.

Additionally, the second transformer of traffic light detection system 101 may generate the traffic light data based on the layout data and the processed image data. In some examples, the second transformer may utilize the layout data to determine a search space within the one or more images of the processed image data to identify which of the one or more objects detected in the one or more images is a traffic light. Further, the second transformer may implement operations that determine portions of the layout data associated with one or more traffic lights that correspond to portions of the search space of the one or more images.

In some examples, the second transformer may utilize the relational attributes of the one or more traffic lights identified in the layout data to determine which of the objects detected in the search space are traffic lights. For example, the layout data may identify a first traffic light, a second traffic light and a third traffic light and portions of HD map data that correspond to each of the first traffic light, the second traffic light and the third traffic light. Additionally, based on the portions of the HD map data included or identified in the layout data that correspond to the first traffic light, the second traffic light and the third traffic light, the second transformer may determine a search space of an image of the processed image data that may include the first traffic light, the second traffic light and the third traffic light. For instance, based on the portions of the HD map data included or identified in the layout data, the second transformer may determine portions of the image of the processed image data that correspond to or match portions of the HD map data that correspond to the first traffic light, the second traffic light or the third traffic light. Additionally, based on the relational attributes of each of the first traffic light, the second traffic light and the third traffic light, the second transformer may determine, within the search space, which of the detected objects are the first traffic light, the second traffic light and the third traffic light.

By way of example, within the search space, there may be multiple detected objects and each of the multiple detected objects may be associated with a particular portion of the search space. Additionally, the relational attributes of the first traffic light, the second traffic light and the third traffic light may indicate that the first traffic light is to the left of the second traffic light and the second traffic light is between the first traffic light and the third traffic light and on the left of the third traffic light. Based on the relational attributes of the first traffic light, the second traffic light and the third traffic light and each portion of the search space that is associated with each of the multiple detect objects, the second transformer may determine which detected object corresponds to which traffic light (e.g., the most left portion of the search space that is associated with a first detected object may correspond to the first traffic light). Further, the second transformer may generate traffic light data that identifies, in the image of the processed image data, the first traffic light, the second traffic light and the third traffic light, as well as portions of the image that correspond to each of the first traffic light, the second traffic light and the third traffic light.

Moreover, the second transformer may indicate which of the traffic lights identified in the traffic light data is the primary traffic light. In some examples, based on the layout data, the second transformer may identify which of the traffic lights identified in the image of the processed image data is the primary traffic light. For instance, following the example above, the layout data may indicate that the second traffic light is the primary traffic light. As such, based on the layout data, the second transformer may generate traffic light data that indicates the second traffic light is the primary traffic light.

Further, the second transformer may add to the traffic light data or associate with the traffic light data, attributes of each traffic light identified in the layout data to the corresponding traffic light identified in the one or more images of the processed image data. For example, an attribute of a traffic light identified in the traffic light data may characterize and identify portions of the HD map data that correspond to one or more lighting elements of the traffic light. Additionally, the second transformer may identify or determine, within the image of the processed image data, portions of the image associated with an object determined to be the traffic light. Based on the attribute of the traffic light, the second transformer may determine or identify, within portions of the image associated with the traffic light, one or more portions associated with the lighting element of the traffic light. Further, the second transformer may generate traffic light data that identifies the traffic light, portions of the image of the processed image data that correspond to the traffic light, the lighting elements of the traffic light and portions of the image that correspond to the lighting elements of the traffic light.

In various examples, AV 102 may determine a state of one or more traffic lights identified in one or more images of the image data based on the traffic light data. In some instances, traffic light detection system 101 may identify portions of each of the one or more traffic lights identified in the one or more images of the processed image data that correspond to one or more lighting elements. Based on the identified portions, traffic light detection system 101, may determine the state of the corresponding traffic light. For example, traffic light data may identify a portion of an image of the processed image data corresponding to one or more lighting elements of a traffic light. Based on the traffic light data, traffic light detection system 101, may determine a state of the corresponding traffic light by examining the characteristics or attributes of the one or more lighting elements (e.g., color and/or shape of the lighting elements). For instance, the lighting element may illuminate an arrow facing right. Further the lighting element may be illuminated green in the image. As such, traffic light detection system 101 may determine, based on the characteristics of the lighting element, that the lighting element indicates that vehicles are allowed to turn right. In another instance, the lighting element may illuminate a circular shape. Further the lighting element may be illuminated red in the image. As such, traffic light detection system 101 may determine, based on the characteristics of the lighting element, that the lighting element indicates that vehicles are to stop in front of the lighting element or the traffic light of the lighting element. In various examples, one or more other systems/stacks of AV 102 may make similar determinations related to the status or state of the one or more traffic lights identified in one or more images of the image data based on the traffic light data.

Additionally, the state and/or status of the traffic light may be utilized to update one or more of the set of operations of the decision information. For example, while AV 102 is stopped in front of multiple side-by-side traffic lights, the one or more sensors of AV 102 may capture an image of the multiple side-by-side traffic lights. Additionally, the traffic light detection system 101 may obtain traffic light data associated with the image of the multiple side-by-side traffic lights as described herein. Moreover, the traffic light data may indicate one of the multiple side-by-side traffic lights is the primary traffic light. Further, AV 102, such as planning stack 118 or traffic light detection system 101, may determine the status or state of the primary traffic light and planning stack 118 may update the set of operations based on the determined status or state of the primary traffic light. In some instances, control stack 122 may execute or implement the updated set of operations of the decision information. For instance, the status of the primary traffic may indicate that the lighting elements of the primary traffic light is green or that vehicles are allowed to proceed in accordance with the shape of the lighting elements of the primary traffic light. As such, planning stack 118 may update the set of operations of the decision information to include operations directed to moving AV 102 forward. Additionally, control stack 122 may cause AV 102 to move forward based on the updated set of operations of the decision information.

In some examples, the AV 102 can navigate roadways without a human driver based on sensor signals generated by multiple sensor systems 104, 106, and 108. As described herein, the sensor systems 104-108 can include one or more types of sensors and can be arranged about the AV 102. For instance, the sensor systems 104-108 can include Inertial Measurement Units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LIDAR system, and the sensor system 108 can be a RADAR system. Other examples may include any other number and type of sensors.

The AV 102 can also include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 can include an engine brake, brake pads, actuators, and/or any other suitable componentry configured to assist in decelerating the AV 102. The steering system 134 can include suitable componentry configured to control the direction of movement of the AV 102 during navigation. The safety system 136 can include lights and signal indicators, a parking brake, airbags, and so forth. The cabin system 138 can include cabin temperature control systems, in-cabin entertainment systems, and so forth. In some examples, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

As illustrated in FIG. 1, AV 102 can include a local computing device 110 that is in communication with the sensor systems 104-108, the mechanical systems 130-138, the data center 150, and the client computing device 170, among other systems, such as traffic light detection system 101. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-108; and so forth. In this example, the local computing device 110 includes a perception stack 112, a localization stack 114, a prediction stack 116, a planning stack 118, a communications stack 120, a control stack 122, an AV operational database 124, and an HD geospatial database 126, among other stacks and systems.

Perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the localization stack 114, the HD geospatial database 126, other components of the AV, and other data sources (e.g., the data center 150, the client computing device 170, third party data sources, etc.). The perception stack 112 can detect and classify objects and determine their current locations, speeds, directions, and the like. In addition, the perception stack 112 can determine the free space around the AV 102 (e.g., to maintain a safe distance from other objects, change lanes, park the AV, etc.). The perception stack 112 can identify environmental uncertainties, such as where to look for moving objects, flag areas that may be obscured or blocked from view, and so forth. In some examples, an output of the perception stack 112 can be a bounding area around a perceived object that can be associated with a semantic label that identifies the type of object that is within the bounding area, the kinematic of the object (information about its movement), a tracked path of the object, and a description of the pose of the object (its orientation or heading, etc.).

Localization stack 114 can determine the AV's position and orientation (pose) using different methods from multiple systems (e.g., GPS, IMUs, cameras, LIDAR, RADAR, ultrasonic sensors, the HD geospatial database 126, etc.). For example, in some cases, the AV 102 can compare sensor data captured in real-time by the sensor systems 104-108 to data in the HD geospatial database 126 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

Prediction stack 116 can receive information from the localization stack 114 and objects identified by the perception stack 112 and predict a future path for the objects. In some examples, the prediction stack 116 can output several likely paths that an object is predicted to take along with a probability associated with each path. For each predicted path, the prediction stack 116 can also output a range of points along the path corresponding to a predicted location of the object along the path at future time intervals along with an expected error value for each of the points that indicates a probabilistic deviation from that point.

Planning stack 118 can determine how to maneuver or operate the AV 102 safely and efficiently in its environment. For example, the planning stack 118 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 102 from one point to another and outputs from the perception stack 112, localization stack 114, and prediction stack 116. The planning stack 118 can determine multiple sets of one or more mechanical operations that the AV 102 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 118 can select from multiple backup plans to carry out. For example, while preparing to change lanes to turn right at an intersection, another vehicle may aggressively cut into the destination lane, making the lane change unsafe. The planning stack 118 could have already determined an alternative plan for such an event. Upon its occurrence, it could help direct the AV 102 to go around the block instead of blocking a current lane while waiting for an opening to change lanes.

Control stack 122 can manage the operation of the vehicle propulsion system 130, the braking system 132, the steering system 134, the safety system 136, and the cabin system 138. The control stack 122 can receive sensor signals from the sensor systems 104-108 as well as communicate with other stacks or components of the local computing device 110 or a remote system (e.g., the data center 150) to effectuate operation of the AV 102. For example, the control stack 122 can implement the final path or actions from the multiple paths or actions provided by the planning stack 118. This can involve turning the routes and decisions from the planning stack 118 into commands for the actuators that control the AV's steering, throttle, brake, and drive unit.

Communications stack 120 can transmit and receive signals between the various stacks and other components of the AV 102 and between the AV 102, the data center 150, the client computing device 170, and other remote systems. The communications stack 120 can enable the local computing device 110 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). Communications stack 120 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Low Power Wide Area Network (LPWAN), Bluetooth®, infrared, etc.).

The HD geospatial database 126 can store HD maps and related data of the streets upon which the AV 102 travels. In some examples, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include three-dimensional (3D) attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

AV operational database 124 can store raw AV data generated by the sensor systems 104-108, stacks 112-122, and other components of the AV 102 and/or data received by the AV 102 from remote systems (e.g., the data center 150, the client computing device 170, etc.). In some examples, the raw AV data can include HD LIDAR point cloud data, image data, RADAR data, GPS data, and other sensor data that the data center 150 can use for creating or updating AV geospatial data or for creating simulations of situations encountered by AV 102 for future testing or training of various machine learning algorithms that are incorporated in the local computing device 110.

Data center 150 can include a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and/or any other network. The data center 150 can include one or more computing devices remote to the local computing device 110 for managing a fleet of AVs and AV-related services. For example, in addition to managing the AV 102, the data center 150 may also support a ride-hailing service (e.g., a ridesharing service), a delivery service, a remote/roadside assistance service, street services (e.g., street mapping, street patrol, street cleaning, street metering, parking reservation, etc.), and the like.

Data center 150 can send and receive various signals to and from the AV 102 and the client computing device 170. These signals can include sensor data captured by the sensor systems 104-108, roadside assistance requests, software updates, ride-hailing/ridesharing pick-up and drop-off instructions, and so forth. In this example, the data center 150 includes a data management platform 152, an Artificial Intelligence/Machine Learning (AI/ML) platform 154, a simulation platform 156, a remote assistance platform 158, and a ride-hailing platform 160, and a map management platform 162, among other systems.

Data management platform 152 can be a “big data” system capable of receiving and transmitting data at high velocities (e.g., near real-time or real-time), processing a large variety of data and storing large volumes of data (e.g., terabytes, petabytes, or more of data). The varieties of data can include data having different structures (e.g., structured, semi-structured, unstructured, etc.), data of different types (e.g., sensor data, mechanical system data, ride-hailing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), and/or data having other characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ride-hailing platform 160, the map management platform 162, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

Simulation platform 156 can enable testing and validation of the algorithms, machine learning models, neural networks, and other development efforts for the AV 102, the remote assistance platform 158, the ride-hailing platform 160, the map management platform 162, and other platforms and systems. Simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from a cartography platform (e.g., map management platform 162); modeling the behavior of other vehicles, bicycles, pedestrians, and other dynamic elements; simulating inclement weather conditions, different traffic scenarios; and so on.

Remote assistance platform 158 can generate and transmit instructions regarding the operation of the AV 102. For example, in response to an output of the AI/ML platform 154 or other system of the data center 150, the remote assistance platform 158 can prepare instructions for one or more stacks or other components of the AV 102.

Ride-hailing platform 160 can interact with a customer of a ride-hailing service via a ride-hailing application 172 executing on the client computing device 170. The client computing device 170 can be any type of computing system such as, for example and without limitation, a server, desktop computer, laptop computer, tablet computer, smartphone, smart wearable device (e.g., smartwatch, smart eyeglasses or other Head-Mounted Display (HMD), smart ear pods, or other smart in-ear, on-ear, or over-ear device, etc.), gaming system, or any other computing device for accessing the ride-hailing application 172. The client computing device 170 can be a customer's mobile computing device or a computing device integrated with the AV 102 (e.g., the local computing device 110). The ride-hailing platform 160 can receive requests to pick up or drop off from the ride-hailing application 172 and dispatch the AV 102 for the trip.

Map management platform 162 can provide a set of tools for the manipulation and management of geographic and spatial (geospatial) and related attribute data. The data management platform 152 can receive LIDAR point cloud data, image data (e.g., still image, video, etc.), RADAR data, GPS data, and other sensor data (e.g., raw data) from one or more AVs 102, Unmanned Aerial Vehicles (UAVs), satellites, third-party mapping services, and other sources of geospatially referenced data. The raw data can be processed, and map management platform 162 can render base representations (e.g., tiles (2D), bounding volumes (3D), etc.) of the AV geospatial data to enable users to view, query, label, edit, and otherwise interact with the data. Map management platform 162 can manage workflows and tasks for operating on the AV geospatial data. Map management platform 162 can control access to the AV geospatial data, including granting or limiting access to the AV geospatial data based on user-based, role-based, group-based, task-based, and other attribute-based access control mechanisms. Map management platform 162 can provide version control for the AV geospatial data, such as to track specific changes that (human or machine) map editors have made to the data and to revert changes when necessary. Map management platform 162 can administer release management of the AV geospatial data, including distributing suitable iterations of the data to different users, computing devices, AVs, and other consumers of HD maps. Map management platform 162 can provide analytics regarding the AV geospatial data and related data, such as to generate insights relating to the throughput and quality of mapping tasks.

In some embodiments, the map viewing services of map management platform 162 can be modularized and deployed as part of one or more of the platforms and systems of the data center 150. For example, the AI/ML platform 154 may incorporate the map viewing services for visualizing the effectiveness of various object detection or object classification models, the simulation platform 156 may incorporate the map viewing services for recreating and visualizing certain driving scenarios, the remote assistance platform 158 may incorporate the map viewing services for replaying traffic incidents to facilitate and coordinate aid, the ride-hailing platform 160 may incorporate the map viewing services into the ride hailing application 172 to enable passengers to view the AV 102 in transit enroute to a pick-up or drop-off location, and so on.

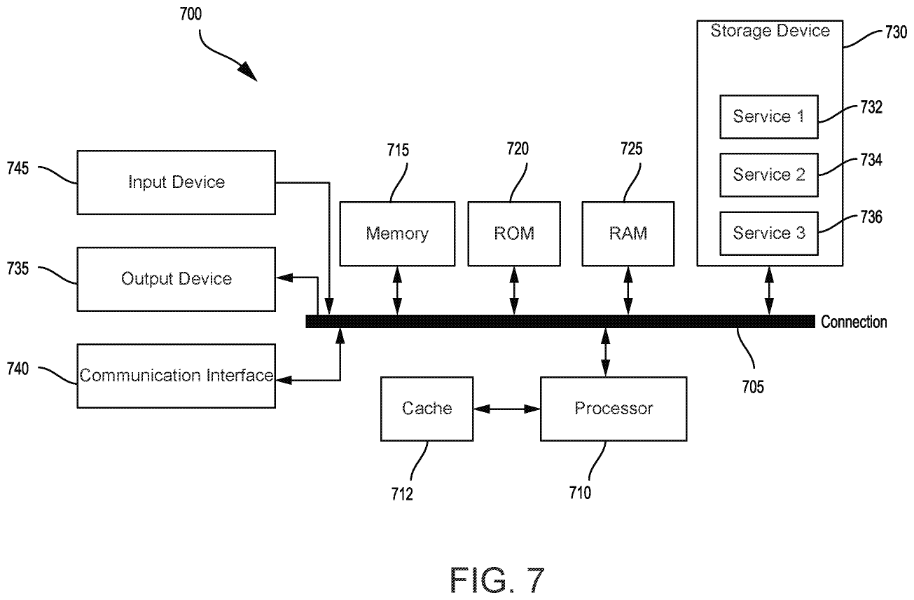

While the AV 102, the local computing device 110, and the autonomous vehicle environment 100 are shown to include certain systems and components, one of ordinary skill will appreciate that the AV 102, the local computing device 110, and/or the autonomous vehicle environment 100 can include more or fewer systems and/or components than those shown in FIG. 1. For example, the AV 102 can include other services than those shown in FIG. 1 and the local computing device 110 can also include, in some instances, one or more memory devices (e.g., RAM, ROM, cache, and/or the like), one or more network interfaces (e.g., wired and/or wireless communications interfaces and the like), and/or other hardware or processing devices that are not shown in FIG. 1. An illustrative example of a computing device and hardware components that can be implemented with the local computing device 110 is described below with respect to FIG. 7.

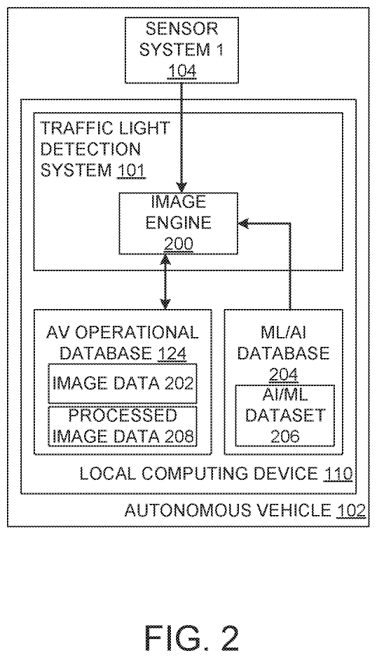

FIG. 2-4 illustrate portions of the AV environment 100, in accordance with some exemplary embodiments. Referring to FIG. 2, one or more processors of local computing device 110 may execute image engine 200 of traffic light detection system 101. Executed image engine 200 may obtain from one or more sensors of sensor system 1 104, such as a camera system, image data 202 generated by the one or more sensors of sensor system 1 104. As described herein, the one or more sensors of sensor system 1 104 may capture one or more images of an environment AV 102 is in. In some instances, the one or more images of the environment may include one or more traffic lights. By way of example, while AV 102 is stopped at an intersection, the one or more sensors of sensor system 1 104, such as a still image camera or a video camera, may capture one or more images of the environment that AV 102 is in. Additionally, the one or more images of the environment may include one or more traffic lights at the intersection. Further, the one or more sensors of sensor system 1 104 may generate image data 202 including the one or more captured images of the environment that AV 102 is in. In some instances, executed image engine 200 may store within one or more tangle non-transitory memories of local computing device 110, such as AV operational database 124, image data 202.

Additionally, executed image engine 200 may process image data 202 utilizing one or more trained artificial intelligence or machine learning (AI/ML) processes to identify one or more objects within the one or more images of image data 202. For example, executed image engine 200 may obtain an AI/ML dataset, such as AI/ML dataset 206, that includes one or more parameters of a trained AI/ML process associated with object detection within one or more images. Additionally, based on the AI/ML dataset, executed image engine 200 may apply the trained AI/ML process to one or more images of image data 202. Based on the application of the trained AI/ML process to the one or more images, executed image engine 200 may generate processed image data 208. As described herein, processed image data 208 may identify one or more objects within each of the one or more images and portions of the one or more images that correspond to each of the one or more identified objects. In some instances, executed image engine 200 may include the one or more images of image data 202 within one or more portions of processed image data. In other instances, executed image engine 200 may store within one or more tangle non-transitory memories of local computing device 110, such as AV operational database 124, the processed image data, such as processed image data 208.

In some examples, and as illustrated in FIG. 2, executed image engine 200, may obtain AI/ML dataset 206 from one or more tangible non-transitory memories of local computing device 110, such as AI/ML database 204. In such examples, AI/ML database 204 may store one or more AI/ML datasets, such as AI/ML dataset 206, provided by AI/ML platform 154. Additionally, AI/ML platform 154 may transmit, over one or more networks as described herein, and to AV 102, one or more AI/ML datasets, such as AI/ML dataset 206. Additionally, local computing device 110 may store, within the one or more tangible non-transitory memories of local computing device 110, such as AI/ML database 204, the one or more AI/ML datasets. In other examples, and not illustrated in FIG. 2, executed image engine 200 may obtain AI/ML dataset 206 from AI/ML platform 154 of data center 150.

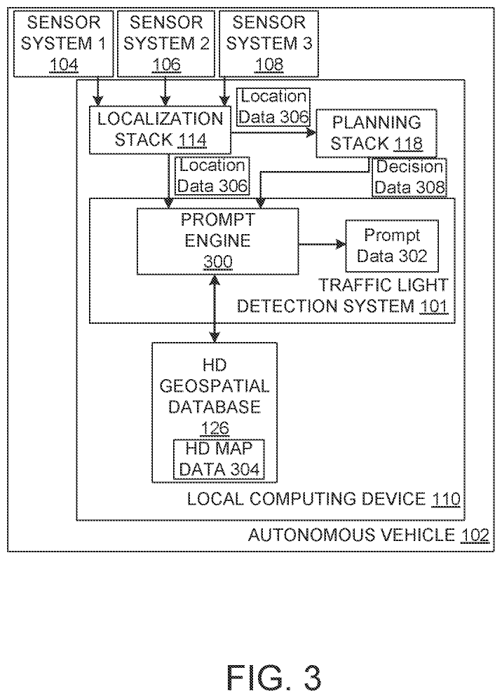

Referring to FIG. 3, one or more processors of local computing device 110 may execute prompt engine 300 of traffic light detection system 101. Executed prompt engine 300 may generate prompt 302. As described herein, prompt 302 may indicate a search space or portions of the captured images of processed image data 208 that traffic light engine 400, when executed by one or more processors of local computing device 110, is to focus on.

In some examples prompt 302 may include one or more portions of high-definition (HD) map data 304. As described herein, the one or more portions of the HD map data 304 may correspond to an area, location or environment the one or more images of processed image data 208 were captured in. In such examples, executed prompt engine 300 may receive location data 306 from localization stack 114. As described herein, location data 306 may include location and/or pose information associated with the one or more images captured by one or more sensors of sensor system 1 104. Additionally, executed prompt engine 300 may receive, from localization stack 114, location data indicating a location and/or pose of AV 102. Moreover, the location of AV 102 may be a current location of AV 102 and the current location may be where the one or more images were captured by the one or more sensors of AV 102. Further, the pose of AV 102 may be the position and orientation of AV 102 and may indicate a direction where the front of AV 102 was facing when the one or more images were captured by the one or more sensors of AV 102 and the field of view of each of the one or more sensors of AV 102. Based on location data 306, executed prompt engine 300 may access HD geospatial database 126 to obtain one or more portions of HD map data 304 associated with the environment that was captured in the one or more images of processed image data 208. For instance, executed prompt engine 300 may access HD geospatial database 126 to obtain one or more portions of HD map data 304 associated with the location and pose of AV 102 based on location data 306. Further, executed prompt engine 300 may generate prompt 302 and package within one or more portions of prompt 302 the obtained one or more portions of HD map data 304.

In some examples, localization stack 114 may generate location data 306 based on sensor data generated by one or more of sensor system 1 104, sensor system 2 106 and sensor system 3 108 and HD map data 304. For example, localization stack 114 may compare sensor data captured in real-time by the sensor systems 104-108 to HD map data 304 in the HD geospatial database 126 to determine its precise (e.g., accurate to the order of a few centimeters or less) position/location and orientation, as described herein.

Additionally, the set of data points included in the one or more portions of HD map data 304 may represent a single spatial measurement on the surface of one or more traffic lights included in a location the one or more portions of HD map data 304 correspond to. Further, attribute data may be included in the one or more portions of HD map data 304 that characterize one or more attributes of the one or more traffic lights. Examples of the one or more attributes include a location of a corresponding traffic light, an orientation of the corresponding traffic light, a size of the corresponding traffic light, a shape of the corresponding traffic light, number of lighting elements of the corresponding traffic light (e.g., bulb, light emitting diode, etc.), and a size of each of the lighting elements of the corresponding traffic light and a shape of each of the lighting elements of the corresponding traffic light. Further, executed prompt engine 300 may generate prompt 302 and package within one or more portions of prompt 302 the obtained one or more portions of HD map data 304 along with the attribute data.

Additionally, prompt 302 may indicate which traffic light, in the one or more portions of HD map data 304, is the primary traffic light (e.g., the traffic light that most likely affects the operation of AV 102). Moreover, the primary traffic light may be in one or more images of processed image data 208 based on the primary traffic light identified in prompt 302. For example, executed prompt engine 300 may receive, decision data 308 generated by planning stack 118. As described herein, decision data 308 may include decision information that identifies and characterizes a set of operations that AV 102 may perform. Additionally, planning stack 118 may determine one or the set of operations based in part on a location and/or pose of AV 102 indicated in location data 306. Moreover, based on the data points of the one or more obtained portions of HD map data 304, executed prompt engine 300 may determine whether any traffic lights are included in the one or more obtained portions of HD map.

In examples where executed prompt engine 300 determines one or more traffic lights are included in the one or more portions of HD map data 304, executed prompt engine 300 may determine whether the one or more traffic lights are facing AV 102. For example, based on the location and/or pose of AV 102 as indicated in location data 306 and the data points that are associated with each of the one or more traffic lights and associated attributes, executed prompt engine 300 may determine whether each of the one or more traffic lights, such as the lighting elements of each of the one or more traffic lights, are facing the front of AV 102.

In examples where executed prompt engine 300, determines one or more traffic lights are facing AV 102, executed prompt engine 300 may determine whether a particular one of the one or more traffic lights that are facing AV 102 would affect the operation of AV 102. In some examples and based on one or more attributes of each of the one or more traffic lights, such as the shape of the lighting element and/or the state of the lighting element (e.g., the color of the lighting element), and the decision information, executed prompt engine 300 may determine whether a particular one of the one or more traffic lights would affect the operation of AV 102.

In such an example, the one or more attributes of the traffic light may indicate whether the state of the traffic light would affect the operation of AV 102. Additionally, executed prompt engine 300 may generate data indicating which of the one or more traffic lights identified in the one or more obtained portions of HD map data 304 would affect the operation of AV 102. Moreover, the data may indicate that such traffic light is the primary traffic light. Further, executed prompt engine 300 determines may further package within one or more portions of prompt 302 the data indicating such traffic light is the primary traffic light.

By way of example, AV 102 may be approaching an intersection of a three-lane road all going north to south. Additionally, AV 102 is on the left most lane and as indicated by decision data 308, one or a set of operations of AV 102 may include turning left at the intersection. Moreover, the one or more sensors of sensor system 1 104 may capture an image of the intersection and executed prompt engine 300 may obtain the one or more portions of HD map data 304 associated with the intersection captured in the image. As described herein, the one or more portions of HD map data 304 may identify a first traffic light, a second traffic light and a third traffic light, and portions of the one or more portions of HD map data 304 that correspond to each of the first traffic light, the second traffic light and the third traffic light. Additionally, the one or more portions of HD map data 304 may identify and characterize one or more attributes of each of the first traffic light, the second traffic light and the third traffic light. Based on the one or more portions of HD map data 304, executed prompt engine 300 may determine there are three traffic lights-a first traffic light, a second traffic light, and a third traffic light, in the one or more portions of HD map data 304, and corresponding attributes of each of the first traffic light, the second traffic light and the third traffic light. Further, based on one or more attributes of each of the first traffic light, the second traffic light and the third traffic included in the one or more portions of HD map data 304 and the current location and pose of AV 102 as indicated in location data 306, executed prompt engine 300 may determine the lighting elements, such as the bulbs, of the first traffic light is facing the front of AV 102 and has a shape of an arrow pointing left and the lighting elements of the second traffic light and the third traffic light have lighting elements that have a shape of a circle. Based on such determinations, executed prompt engine 300 may generate data indicating that the first traffic light would affect the operation of AV 102 and is the primary traffic light. Further, executed prompt engine 300 may package within one or more portions of prompt 302 the data indicating the first traffic light is the primary traffic light.

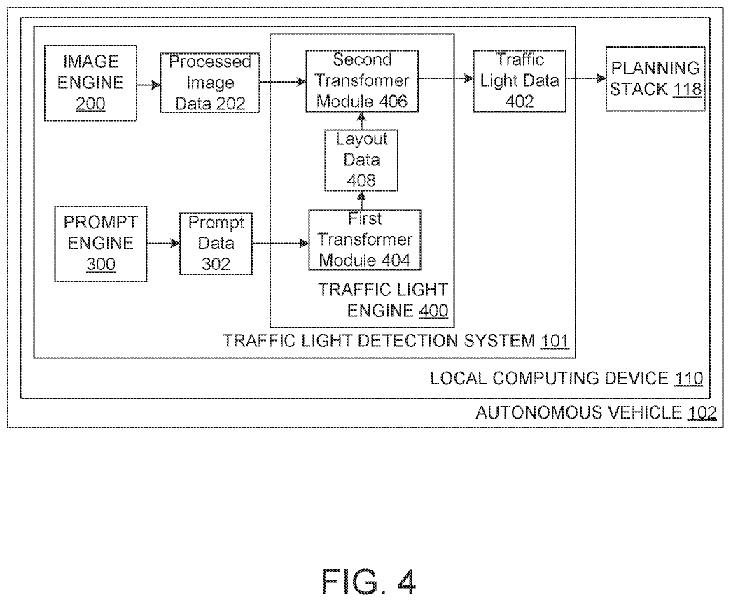

Referring to FIG. 4, one or more processors of local computing device 110 may execute traffic light engine 400 to generate traffic light data 402 based on prompt 302 and processed image data 208. As described herein, traffic light data 402 may identify one or more traffic lights within one or more images of processed image data 208, and portions of the one or more images that correspond to each of the one or more identified traffic lights. Additionally, traffic light data 402 may identify one or more lighting elements, such as bulbs, for each of the one or more traffic lights identified within the one or more images, and portions of the one or more images that correspond to the identified one or more lighting elements. Moreover, traffic light data 402 may indicate a state of each of the one or more identified lighting elements, such as the color of the lighting element and whether it's illuminated. Further, traffic light data 402 may indicate which of the one or more traffic lights identified within the one or more images is the primary traffic light.

As illustrated in FIG. 4, executed traffic light engine 400 may include first transformer module 404 and second transformer module 406. As described herein, first transformer module 404 and second transformer module 406 may generate traffic light data 402 based on prompt 302 and processed image data 208. In some examples, first transformer module 404 may generate layout data 408 based on prompt 302. In such examples first transformer module 404 may obtain prompt 302 from executed prompt engine 300. Additionally, first transformer module 404 may extract from prompt 302, the one or more portions of HD map data 304 and data identifying which traffic light identified in the one or more portions of HD map data 304 is the primary traffic light. Moreover, based on the one or more portions of HD map data 304, first transformer module 404 may generate layout data 408.

As described herein, layout data 408 may identify and characterize each of the traffic lights identified in the one or more portions of HD map data 304, corresponding attributes and relational attributes between each of the traffic lights identified in the one or more portions of HD map data 304. Examples of relational attributes that may be identified in layout data 408 include, spatial relationships between each of the traffic lights, orientation of each of the identified traffic lights with respect to one another, and location/position of each of the identified traffic lights with respect to one another. Additionally, layout data 408 may indicate which portions of the one or more portions of HD map data are associated with each of the identified traffic lights. Further,

Referring back to FIG. 4, second transformer module 406 may generate traffic light data 402 based on layout data 408 and processed image data 208. In some examples, first transformer module 404 may provide as input to second transformer module 406, layout data 408. Additionally, second transformer module 406 may obtain processed image data 208 from executed image engine 200. Moreover, second transformer module 406 may utilize layout data 408 to determine a search space within one or more images of processed image data 208 to determine which of the one or more objects detected in the one or more images is a traffic light.

In some examples, second transformer module 406 may implement operations that determine portions of layout data 408 associated with one or more traffic lights that correspond to portions of the search space of the one or more images of processed image data 208. In some instances, second transformer module 406 may utilize the relational attributes of the one or more traffic lights identified in layout data 408 to determine which of the objects detected in the search space are traffic lights. By way of example, layout data 408 may identify a first traffic light and a second traffic light and portions of HD map data 304 that correspond to each of the first traffic light, and the second traffic light. Based on portions of HD map data 304 included or identified in layout data 408, second transformer module 406 may determine a search space within an image of processed image data 208. As described herein, the search space includes portions of the image that includes at least first detected object and a second detected object that may match portions of the HD map data 304 that correspond to each of the first traffic light and the second traffic light. Additionally, based on the relational attributes of the first traffic light and second traffic light, second transformer module 406 may determine, within the search space, whether the portion of the image corresponding to the first detected object is the first traffic light or the second traffic light and whether the portion of the image corresponding to the second detected object is the first traffic light or the second traffic light. For instance, the relational attributes of the first traffic light and the second traffic light may indicate that the first traffic light is to the left of the second traffic light and the second traffic light is to the right of the first traffic light. As such, based on the relational attributes of the first traffic light and the second traffic light and each portion of the search space that is associated with each of the first detected object and the second detected object, second transformer module 406 may determine which detected object corresponds to which traffic light. For instance, if the first detected object is to the left of the second detect object, second transformer module 406 may determine the first detected object is the first traffic light, while the second detected object is the second traffic light. Alternatively, if the first detected object is to the right of the second detect object, second transformer module 406 may determine the first detected object is the second traffic light, while the second detected object is the first traffic light. Further, second transformer module 406 may generate traffic light data 402 that identifies, for the image of processed image data 208, which detected objects are the first traffic light and the second traffic light, as well as portions of the image that correspond to each of the first traffic light and the second traffic light.

In other instances, there may be a large displacement between the objects identified in process image data 208 and one or more traffic lights identified in layout data 408. In such instances, second transformer module 406 may utilize other attributes, such as the orientation and/or, in instances where there are side-by-side traffic lights, the distance between each traffic light, identified in layout data 408, to determine portions of layout data 408 associated with one or more traffic lights that correspond to portions of the search space of the one or more images of processed image data 208.

In other examples, layout data 408 may indicate which of the identified traffic lights is the primary traffic light. In such examples, second transformer module 406 may obtain portions of layout data 408 that identifies which traffic light is the primary traffic light. Additionally, based on the identified primary traffic light, second transformer module 406 may generate traffic light data that indicates which of the traffic lights identified in the one or more images of processed image data 208 is the primary traffic light. For example, following the example above, layout data 408 may indicate that the second traffic light is the primary traffic light. Additionally, second transformer module 406 may obtain portions of layout data 408 that indicates the second traffic light is the primary traffic light. As such, based on portions of layout data 408 that identify the second traffic light as the primary traffic light, second transformer module 406 may generate traffic light data 402 that indicates the second traffic light is the primary traffic light.

In various examples, second transformer module 406 may add to traffic light data 402 or associate to traffic light data 402, attributes of traffic light identified in the layout data. In such examples, based on layout data 408, second transformer module 406 may identify one or more attributes of each of the traffic lights identified in layout data 408. Additionally, second transformer module 406 may associate, to each of the corresponding traffic lights identified in traffic light data 402, the corresponding one or more attributes. For example, following the example above, layout data 408 may one or more attributes of the first traffic light identified in layout data 408, such as a number of lighting elements for the first traffic light identified in layout data 408, along with the shape of each of the lighting elements. Additionally, second transformer module 406 may identify the one or more attributes of the first traffic light identified in layout data 408. Moreover, second transformer module 406 may add or associate with traffic light data 402 the one or more identified attributes of the first traffic light. As such, the traffic light data 402 may identify one or more traffic lights in the one or more images in processed image data 208 and corresponding portions of the one or more images of each of the one or more traffic lights, as well as one or more attributes of each of the traffic lights, such as a number of lighting elements for each of the one or more traffic lights identified in traffic light data 402, the shape of each of the one or more lighting elements and portions of the one or more images that correspond to each of the one or more lighting elements.

In some examples, AV 102 may determine a state of one or more traffic lights identified in traffic light data 402. Referring to FIG. 4 and in some instances, second transformer module 406 may provide as input to planning stack 118 traffic light data 402. Additionally, planning stack 118 may identify portions of each of the one or more traffic lights identified in the one or more images of processed image data 208 that correspond to one or more lighting elements. Based on the identified portions, planning stack 118, may determine a state of the corresponding traffic light (e.g., the color of a lighting element of the traffic light and corresponding state).

By way of example, planning stack 118 may identify a portion of an image of processed image data 208 corresponding to one or more lighting elements of a traffic light, such as a primary traffic light. Based on the traffic light data, planning stack 118, may examine the characteristics or attributes of the one or more lighting elements of the traffic light, such as the color and/or shape of the one or more lighting elements. For instance, the lighting element may illuminate an arrow pointing right. Further the lighting element may be illuminated green in the image. As such, planning stack 118 may determine, based on the characteristics of the lighting element, the state of the traffic light. The state indicating that the lighting element is a green arrow pointing right indicating that vehicles are allowed to turn right. In another instance, the lighting element may illuminate a circular shape. Further the lighting element may be illuminated red in the image. As such, planning stack 118 may determine, based on the characteristics of the lighting element, the state of the traffic light. The state indicating that the lighting element is a red circle indicating that vehicles are to stop in front of the lighting element or the traffic light of the lighting element. In some instances, planning stack 118 may generate state information based on the determined state. The state information identifying and characterizing the determined state. Additionally, planning stack 118 may, based on the state information, update one or a set of operations that AV 102 may perform based on the determined state of one or more of the traffic lights identified in traffic light data 402.

Alternatively, and in some examples, second transformer module 406 may perform operations that determine the state planning stack 118 of one or more traffic lights identified in traffic light data 402 as similarly described with planning stack 118. In such examples, second transformer module 406 may generate, for each traffic light identified in traffic light data 402, the state information identifying and characterizing the state of a corresponding traffic light. Additionally, second transformer module 406 may provide, as input to planning stack 118, the state information. Planning stack 118 may, based on the state information, update one or a set of operations that AV 102 may perform.

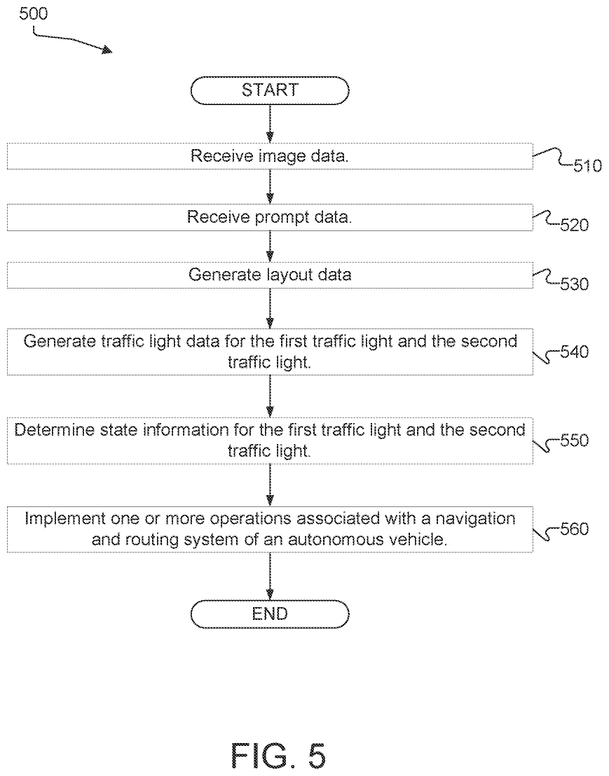

FIG. 5 is a flow chart of an exemplary process 500 for generating traffic light data. In some instances, one or more components of AV environment 100 may perform all or a portion of the steps of exemplary process 500, which include but are not limited to receiving image data, receiving prompt data, generating layout data, generating traffic data for a first traffic light and a second traffic light, determining state information for the first traffic light and the second traffic light and implementing one or more operations associated with a navigation and routing system of an autonomous vehicle.

Referring to FIG. 5, traffic light detection system 101 may receive image data (e.g., step 510). For example, as illustrated in FIG. 2, executed image engine may obtain image data 202 generated by the one or more sensors of sensor system 1 104. As described herein, the one or more sensors of sensor system 1 104 may capture the one or more images of an environment AV 102 and generate image data 202 that include the one or more images. In some instances, the one or more images of the environment may include one or more traffic lights.

In other instances, executed image engine 200 may process image data 202 utilizing one or more trained artificial intelligence or machine learning (AI/ML) processes to identify one or more objects within the one or more images of image data 202. In such instances, executed image engine 200 may generate processed imaged data 208. Additionally, processed image data 208 may identify one or more objects within each of the one or more images and portions of the one or more images that correspond to each of the one or more identified objects. In various instances, executed image engine 200 may include the one or more images of image data 202 within one or more portions of processed image data.

Referring back to FIG. 5, traffic light detection system 101 may receive prompt data (e.g., step 520). As described herein, prompt data may indicate a search space or portions of the captured images of the processed image data that one or more traffic lights may be in. In some examples, prompt data or as illustrated in FIG. 3, prompt 302, may include one or more portions of high-definition (HD) map data, such as the one or more portions of the HD map data.

Additionally, the one or more portions of the HD map data may correspond to an area, location or environment the one or more images of the processed image data were captured in. Moreover, the one or more portions of the HD map data may include a set of data points that may represent a single spatial measurement on the surface of one or more traffic lights included in a location the one or more portions of the HD map data correspond to. Further, attribute data may be included in the one or more portions of the HD map data that characterize one or more attributes of the one or more traffic lights. Examples of the one or more attributes include a location of a corresponding traffic light, an orientation of the corresponding traffic light, a size of the corresponding traffic light, a shape of the corresponding traffic light, number of lighting elements of the corresponding traffic light (e.g., bulb, light emitting diode, etc.), and a size of each of the lighting elements of the corresponding traffic light and a shape of each of the lighting elements of the corresponding traffic light.

In some examples, the prompt data, such as prompt 302, may indicate which traffic light, in the one or more portions of the HD map data, is the primary traffic light (e.g., the traffic light that most likely affects the operation of AV 102). Additionally, traffic light detection system 101 may identify the primary traffic light in the one or more images of the processed image data based on the primary traffic light identified in the prompt data.

Referring back to FIG. 5, traffic light detection system 101 may generate layout data (e.g., step 530). As described herein, layout data may identify each of the traffic lights identified in the one or more portions of HD map data included in the prompt, corresponding attributes and the relational attributes between each of the traffic lights identified in the one or more portions of HD map data (e.g., spatial relationships between each of the traffic lights, orientation of each of the identified traffic lights with respect to one another, and location/position of each of the identified traffic lights with respect to one another). Additionally, traffic light detection system 101 may generate the layout data based on the prompt data.

For example, and as illustrated in FIG. 4, first transformer module 404 may generate layout data 408 based on prompt 302. In such examples first transformer module 404 may obtain prompt 302 from executed prompt engine 300. Additionally, first transformer module 404 may extract from prompt 302, the one or more portions of HD map data 304 and data identifying which traffic light identified in the one or more portions of HD map data 304 is the primary traffic light. Moreover, based on the one or more portions of HD map data 304, first transformer module 404 may generate layout data 408.

Referring back to FIG. 5, traffic light detection system 101 may generate traffic light data for a first traffic light and a second traffic light (e.g., step 540). Additionally, traffic light detection system 101 may generate the traffic data based on the prompt data and the processed image data. As described herein, the traffic light data may identify one or more traffic lights within one or more images of the processed image data, and portions of the one or more images that correspond to each of the one or more identified traffic lights. Additionally, the traffic light data may identify one or more lighting elements, such as bulbs, for each of the one or more traffic lights identified within the one or more images, and portions of the one or more images that correspond to the identified one or more lighting elements. Moreover, the traffic light data may indicate a state of each of the one or more identified lighting elements, such as the color of the lighting element and whether it's illuminated. Further, the traffic light data may indicate which of the one or more traffic lights identified within the one or more images is the primary traffic light.

For example, and as illustrated in FIG. 4, second transformer module 406 may generate traffic light data 402 based on layout data 408 and processed image data 208. In some examples, first transformer module 404 may provide as input to second transformer module 406, layout data 408. Additionally, second transformer module 406 may obtain processed image data 208 from executed image engine 200. Moreover, second transformer module 406 may utilize layout data 408 to determine a search space within one or more images of processed image data 208 to determine which of the one or more objects detected in the one or more images is a traffic light. Further, second transformer module 406 may implement operations that determine, within the search space, portions of layout data 408 associated with one or more traffic lights that correspond to portions of the search space of the one or more images of processed image data 208. In some instances, second transformer module 406 may utilize the relational attributes of each of the traffic lights identified in layout data 408 to determine, within the search space, portions of layout data 408 associated with one or more traffic lights that correspond to portions of the search space of the one or more images of processed image data 208. Based on the determined corresponding portions, second transformer module 406 may generate traffic light data 402 that identifies, for the one or more images of processed image data 208, which detected objects are traffic lights, as well as portions of the one or more images that correspond to each of the first traffic light and the second traffic light. In some instances, the layout data, such as layout data 408, may indicate which of the identified traffic lights in traffic light data is the primary traffic light.

In other instances, the traffic light data may include or maybe associated with attribute data identifying and characterizing one or more attributes of one or more traffic lights identified in the traffic light data. In such instances, traffic light detection system 101, such as the second transformer module 406, may associate or add the attribute data to the traffic light data based on the layout data, such as layout data 408. For example, and as illustrated in FIG. 4, based on layout data 408, second transformer module 406 may identify one or more attributes of each of the traffic lights identified in layout data 408. Additionally, second transformer module 406 may associate, to each of the corresponding traffic lights identified in traffic light data 402, the corresponding one or more attributes (e.g., the number of lighting elements for each of the traffic lights identified in traffic light data 402, and the shape of each of the lighting elements).

Referring back to FIG. 5, traffic light detection system 101 may determine state information for the first traffic light and the second traffic light (e.g., step 550). Additionally, traffic light detection system 101 may implement one or more operations associated with a navigation and routing system of an autonomous vehicle (e.g., step 560). In some examples, traffic light detection system 101, such as second transformer module 406, may determine the state of one or more traffic lights, such as the primary traffic light, identified in the traffic light data, such as traffic light data 402, based on the attributes of each of the one or more traffic lights. Additionally, traffic light detection system may generate state information identifying and characterizing the state of one or more traffic lights, and providing as input to planning stack 118. Planning stack 118 may update one or a set of operations that AV 102 may perform based on the determined state of one or more of the traffic lights identified in the state data.

For example, and as illustrated in FIG. 4, traffic light data 402 may identify a portion of an image of processed image data 208 corresponding to one or more lighting elements of a primary traffic light. Based on traffic light data 402, second transformer module 406, may examine the characteristics or attributes of the one or more lighting elements, such as the color and/or shape of the one or more lighting elements. For instance, the lighting element may illuminate an arrow pointing right. Further the lighting element may be illuminated green in the image. As such, second transformer module 406 may determine, based on the characteristics of the lighting element, the state of the traffic is that the lighting element indicates that vehicles are allowed to turn right. Based on the determined state, second transformer module 406 may generate state information identifying and characterizing the determined state (e.g., the lighting element is a green right arrow indicating that vehicles are allowed to turn right). In some instances, second transformer module 406 may provide as input to planning stack 118, the state information. In such instances, planning stack 118 may, based on the state information, update the one or more operations that AV 102 may perform based on the determined state of one or more of the traffic lights identified in traffic light data 402 (e.g., turn right at the primary traffic light).

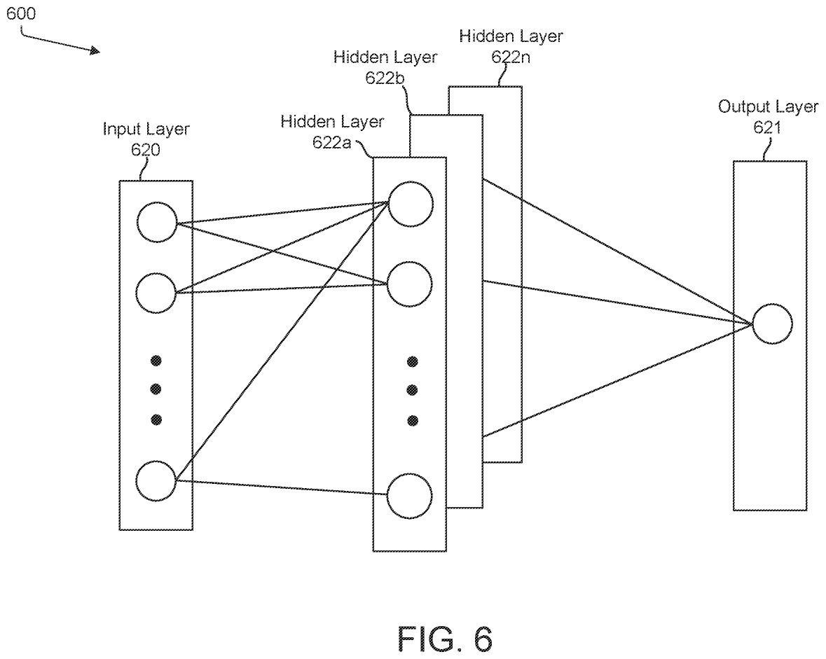

In FIG. 6, the disclosure now turns to a further discussion of models that can be used through the environments and techniques described herein. FIG. 6 is an example of a deep learning neural network 600 that can be used to implement all or a portion of the systems and techniques described herein (e.g., neural network 600 can be used to implement a perception module (or perception system) as discussed above). An input layer 620 can be configured to receive sensor data and/or data relating to an environment surrounding an AV. Neural network 600 includes multiple hidden layers 622a, 622b, through 622n. The hidden layers 622a, 622b, through 622n include “n” number of hidden layers, where “n” is an integer greater than or equal to one. The number of hidden layers can be made to include as many layers as needed for the given application. Neural network 600 further includes an output layer 621 that provides an output resulting from the processing performed by the hidden layers 622a, 622b, through 622n.

Neural network 600 is a multi-layer neural network of interconnected nodes. Each node can represent a piece of information. Information associated with the nodes is shared among the different layers and each layer retains information as information is processed. In some cases, the neural network 600 can include a feed-forward network, in which case there are no feedback connections where outputs of the network are fed back into itself. In some cases, the neural network 600 can include a recurrent neural network, which can have loops that allow information to be carried across nodes while reading in input.

Information can be exchanged between nodes through node-to-node interconnections between the various layers. Nodes of the input layer 620 can activate a set of nodes in the first hidden layer 622a. For example, as shown, each of the input nodes of the input layer 620 is connected to each of the nodes of the first hidden layer 622a. The nodes of the first hidden layer 622a can transform the information of each input node by applying activation functions to the input node information. The information derived from the transformation can then be passed to and can activate the nodes of the next hidden layer 622b, which can perform their own designated functions. Example functions include convolutional, up-sampling, data transformation, and/or any other suitable functions. The output of the hidden layer 622b can then activate nodes of the next hidden layer, and so on. The output of the last hidden layer 622n can activate one or more nodes of the output layer 621, at which an output is provided. In some cases, while nodes in the neural network 600 are shown as having multiple output lines, a node can have a single output and all lines shown as being output from a node represent the same output value.

In some cases, each node or interconnection between nodes can have a weight that is a set of parameters derived from the training of the neural network 600. Once the neural network 600 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 600 to be adaptive to inputs and able to learn as more and more data is processed.

The neural network 600 is pre-trained to process the features from the data in the input layer 620 using the different hidden layers 622a, 622b, through 622n in order to provide the output through the output layer 621.

In some cases, the neural network 600 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network 600 is trained well enough so that the weights of the layers are accurately tuned.

To perform training, a loss function can be used to analyze error in the output. Any suitable loss function definition can be used, such as a Cross-Entropy loss. Another example of a loss function includes the mean squared error (MSE), defined as E_total=Σ(½ (target-output)\hat{ }2). The loss can be set to be equal to the value of E_total.

The loss (or error) will be high for the initial training data since the actual values will be much different than the predicted output. The goal of training is to minimize the amount of loss so that the predicted output is the same as the training output. The neural network 600 can perform a backward pass by determining which inputs (weights) most contributed to the loss of the network, and can adjust the weights so that the loss decreases and is eventually minimized.

The neural network 600 can include any suitable deep network. One example includes a Convolutional Neural Network (CNN), which includes an input layer and an output layer, with multiple hidden layers between the input and out layers. The hidden layers of a CNN include a series of convolutional, nonlinear, pooling (for downsampling), and fully connected layers. The neural network 600 can include any other deep network other than a CNN, such as an autoencoder, Deep Belief Nets (DBNs), Recurrent Neural Networks (RNNs), among others.

As understood by those of skill in the art, machine-learning based classification techniques can vary depending on the desired implementation. For example, machine-learning classification schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to: a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

FIG. 7 illustrates an example processor-based system with which some aspects of the subject technology can be implemented. For example, processor-based system 700 can be any computing device making up, or any component thereof in which the components of the system are in communication with each other using connection 705. Connection 705 can be a physical connection via a bus, or a direct connection into processor 710, such as in a chipset architecture. Connection 705 can also be a virtual connection, networked connection, or logical connection.

In some embodiments, computing system 700 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 700 includes at least one processing unit (Central Processing Unit (CPU) or processor) 710 and connection 705 that couples various system components including system memory 715, such as Read-Only Memory (ROM) 720 and Random-Access Memory (RAM) 725 to processor 710. Computing system 700 can include a cache of high-speed memory 712 connected directly with, in close proximity to, or integrated as part of processor 710.

Processor 710 can include any general-purpose processor and a hardware service or software service, such as services 732, 734, and 736 stored in storage device 730, configured to control processor 710 as well as a special-purpose processor where software instructions are incorporated into the actual processor design. Processor 710 may essentially be a completely self-contained computing system, containing multiple cores or processors, a bus, memory controller, cache, etc. A multi-core processor may be symmetric or asymmetric.

To enable user interaction, computing system 700 includes an input device 745, which can represent any number of input mechanisms, such as a microphone for speech, a touch-sensitive screen for gesture or graphical input, keyboard, mouse, motion input, speech, etc. Computing system 700 can also include output device 735, which can be one or more of a number of output mechanisms known to those of skill in the art. In some instances, multimodal systems can enable a user to provide multiple types of input/output to communicate with computing system 700. Computing system 700 can include communications interface 740, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communications interface 740 may also include one or more Global Navigation Satellite System (GNSS) receivers or transceivers that are used to determine a location of the computing system 700 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 730 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Atatic RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L #), Resistive RAM (RRAM/ReRAM), Phase Change Memory (PCM), Spin Transfer Torque RAM (STT-RAM), another memory chip or cartridge, and/or a combination thereof.

Storage device 730 can include software services, servers, services, etc., that when the code that defines such software is executed by the processor 710, it causes the system 700 to perform a function. In some embodiments, a hardware service that performs a particular function can include the software component stored in a computer-readable medium in connection with the necessary hardware components, such as processor 710, connection 705, output device 735, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

Illustrative examples of the disclosure include:
Aspect 1: A system comprising: a communications interface; a memory storing instructions; and at least one processor coupled to the communications interface and to the memory, the at least one processor being configured to execute the instructions to: receive image data for a location navigated by an autonomous vehicle (AV); receive prompt data associated with the location, the prompt data identifying a search space for traffic light detection; generate layout data based on the prompt data, the layout data including information characterizing one or more relational attributes for a first traffic light and a second traffic light; generate traffic light data for the first traffic light and the second traffic light based on the image data and the layout data, the traffic light data identifying one or more portions of an image of the image data that correspond to the first traffic light, and one or more portions of the image that correspond to the second traffic light; determine state information for the first traffic light based on the traffic light data; and implement one or more operations associated with a navigation and routing system of the autonomous vehicle based on the state information.
Aspect 2. The system of Aspect 1, wherein the traffic light data indicates, within the one or more portions of the image that correspond to the first traffic light, one or more portions of the image that correspond to one or more lighting elements, and wherein the state information indicates, for each of the one or more lighting elements, a corresponding state.
Aspect 3. The system of Aspect 1, wherein the one or more relational attributes identify relative locations and orientations of the first traffic light and the second traffic light.
Aspect 4. The system of Aspect 1, wherein to generate the traffic light data, the at least one processor is further configured to: implement operations that match one or more portions of the layout data to the image data, and wherein the traffic light data is based on the one or more matched portions of the layout data and the image data.
Aspect 5. The system of Aspect 1, wherein the prompt data further identifies the first traffic light as a primary traffic light, the primary traffic light being a traffic light that most likely affects the one or more operations of the AV.
Aspect 6. The system of Aspect 1, the at least one processor is further configured to: determine whether the first traffic light is a primary traffic light with respect to the AV based on navigation data of the AV.
Aspect 7. The system of Aspect 1, wherein the search space is based on a pose of the AV.
Aspect 8. A computer-implemented method comprising: receiving image data for a location navigated by an autonomous vehicle (AV); receiving prompt data associated with the location, the prompt data identifying a search space for traffic light detection; generating layout data based on the prompt data, the layout data including information characterizing one or more relational attributes for a first traffic light and a second traffic light; generating traffic light data for the first traffic light and the second traffic light based on the image data and the layout data, the traffic light data identifying one or more portions of an image of the image data that correspond to the first traffic light, and one or more portions of the image that correspond to the second traffic light; determining state information for the first traffic light based on the traffic light data; and implementing one or more operations associated with a navigation and routing system of the autonomous vehicle based on the state information.
Aspect 9. The computer-implemented method of Aspect 8, wherein the traffic light data indicates, within the one or more portions of the image that correspond to the first traffic light, one or more portions of the image that correspond to one or more lighting elements, and wherein the state information indicates, for each of the one or more lighting elements, a corresponding state.
Aspect 10. The computer-implemented method of Aspect 8, wherein the one or more relational attributes identify relative locations and orientations of the first traffic light and the second traffic light.
Aspect 11. The computer-implemented method of Aspect 8, wherein generating the traffic light data includes: implementing operations that match one or more portions of the layout data to the image data, and wherein the traffic light data is based on the one or more matched portions of the layout data and the image data.
Aspect 12. The computer-implemented method of Aspect 8, wherein the prompt data further identifies the first traffic light as a primary traffic light, the primary traffic light being a traffic light that most likely affects the one or more operations of the AV.
Aspect 13. The computer-implemented method of Aspect 8, further comprising: determining whether the first traffic light is a primary traffic light with respect to the AV based on navigation data of the AV.
Aspect 14. The computer-implemented method of Aspect 8, wherein the search space is based on a pose of the AV.
Aspect 15. A tangible, non-transitory computer readable medium storing instructions that, when executed by at least one processor, cause the at least one processor to perform operations comprising: receiving image data for a location navigated by an autonomous vehicle (AV); receiving prompt data associated with the location, the prompt data identifying a search space for traffic light detection; generating layout data based on the prompt data, the layout data including information characterizing one or more relational attributes for a first traffic light and a second traffic light; generating traffic light data for the first traffic light and the second traffic light based on the image data and the layout data, the traffic light data identifying one or more portions of an image of the image data that correspond to the first traffic light, and one or more portions of the image that correspond to the second traffic light; determining state information for the first traffic light based on the traffic light data; and implementing one or more operations associated with a navigation and routing system of the autonomous vehicle based on the state information.
Aspect 16. The tangible, non-transitory computer readable medium of Aspect 15, wherein the traffic light data indicates, within the one or more portions of the image that correspond to the first traffic light, one or more portions of the image that correspond to one or more lighting elements, and wherein the state information indicates, for each of the one or more lighting elements, a corresponding state.
Aspect 17. The tangible, non-transitory computer readable medium of Aspect 15, wherein the one or more relational attributes identify relative locations and orientations of the first traffic light and the second traffic light.
Aspect 18. The tangible, non-transitory computer readable medium of Aspect 15, wherein generating the traffic light data includes: implementing operations that match one or more portions of the layout data to the image data, and wherein the traffic light data is based on the one or more matched portions of the layout data and the image data.
Aspect 19. The tangible, non-transitory computer readable medium of Aspect 15, wherein the prompt data further identifies the first traffic light as a primary traffic light, the primary traffic light being a traffic light that most likely affects the one or more operations of the AV.
Aspect 20. The tangible, non-transitory computer readable medium of Aspect 15, wherein the at least one processor performs operations further comprising: determining whether the first traffic light is a primary traffic light with respect to the AV based on navigation data of the AV.
Aspect 21. The tangible, non-transitory computer readable medium of Aspect 15, wherein the search space is based on a pose of the AV.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

What is claimed is:

1. An system comprising:
a communications interface;
a memory storing instructions; and
at least one processor coupled to the communications interface and to the memory, the at least one processor being configured to execute the instructions to:
receive image data for a location navigated by an autonomous vehicle (AV);
receive prompt data associated with the location, the prompt data identifying a search space for traffic light detection;
generate layout data based on the prompt data, the layout data including information characterizing one or more relational attributes for a first traffic light and a second traffic light;
generate traffic light data for the first traffic light and the second traffic light based on the image data and the layout data, the traffic light data identifying one or more portions of an image of the image data that correspond to the first traffic light, and one or more portions of the image that correspond to the second traffic light;
determine state information for the first traffic light based on the traffic light data; and
implement one or more operations associated with a navigation and routing system of the autonomous vehicle based on the state information.

2. The system of claim 1, wherein the traffic light data indicates, within the one or more portions of the image that correspond to the first traffic light, one or more portions of the image that correspond to one or more lighting elements, and wherein the state information indicates, for each of the one or more lighting elements, a corresponding state.

3. The system of claim 1, wherein the one or more relational attributes identify relative locations and orientations of the first traffic light and the second traffic light.

4. The system of claim 1, wherein to generate the traffic light data, the at least one processor is further configured to:
implement operations that match one or more portions of the layout data to the image data, and wherein the traffic light data is based on the one or more matched portions of the layout data and the image data.

5. The system of claim 1, wherein the prompt data further identifies the first traffic light as a primary traffic light, the primary traffic light being a traffic light that most likely affects the one or more operations of the AV.

6. The system of claim 1, the at least one processor is further configured to:
determine whether the first traffic light is a primary traffic light with respect to the AV based on navigation data of the AV.

7. The system of claim 1, wherein the search space is based on a pose of the AV.

8. A computer-implemented method comprising:
receiving image data for a location navigated by an autonomous vehicle (AV);
receiving prompt data associated with the location, the prompt data identifying a search space for traffic light detection;
generating layout data based on the prompt data, the layout data including information characterizing one or more relational attributes for a first traffic light and a second traffic light;
generating traffic light data for the first traffic light and the second traffic light based on the image data and the layout data, the traffic light data identifying one or more portions of an image of the image data that correspond to the first traffic light, and one or more portions of the image that correspond to the second traffic light;
determining state information for the first traffic light based on the traffic light data; and
implementing one or more operations associated with a navigation and routing system of the autonomous vehicle based on the state information.

9. The computer-implemented method of claim 8, wherein the traffic light data indicates, within the one or more portions of the image that correspond to the first traffic light, one or more portions of the image that correspond to one or more lighting elements, and wherein the state information indicates, for each of the one or more lighting elements, a corresponding state.

10. The computer-implemented method of claim 8, wherein the one or more relational attributes identify relative locations and orientations of the first traffic light and the second traffic light.

11. The computer-implemented method of claim 8, wherein generating the traffic light data includes:
implementing operations that match one or more portions of the layout data to the image data, and wherein the traffic light data is based on the one or more matched portions of the layout data and the image data.

12. The computer-implemented method of claim 8, wherein the prompt data further identifies the first traffic light as a primary traffic light, the primary traffic light being a traffic light that most likely affects the one or more operations of the AV.

13. The computer-implemented method of claim 8, further comprising:
determining whether the first traffic light is a primary traffic light with respect to the AV based on navigation data of the AV.

14. The computer-implemented method of claim 8, wherein the search space is based on a pose of the AV.

15. A tangible, non-transitory computer readable medium storing instructions that, when executed by at least one processor, cause the at least one processor to perform operations comprising:
receiving image data for a location navigated by an autonomous vehicle (AV);
receiving prompt data associated with the location, the prompt data identifying a search space for traffic light detection;
generating layout data based on the prompt data, the layout data including information characterizing one or more relational attributes for a first traffic light and a second traffic light;
generating traffic light data for the first traffic light and the second traffic light based on the image data and the layout data, the traffic light data identifying one or more portions of an image of the image data that correspond to the first traffic light, and one or more portions of the image that correspond to the second traffic light;
determining state information for the first traffic light based on the traffic light data; and
implementing one or more operations associated with a navigation and routing system of the autonomous vehicle based on the state information.

16. The tangible, non-transitory computer readable medium of claim 15, wherein the traffic light data indicates, within the one or more portions of the image that correspond to the first traffic light, one or more portions of the image that correspond to one or more lighting elements, and wherein the state information indicates, for each of the one or more lighting elements, a corresponding state.

17. The tangible, non-transitory computer readable medium of claim 15, wherein the one or more relational attributes identify relative locations and orientations of the first traffic light and the second traffic light.

18. The tangible, non-transitory computer readable medium of claim 15, wherein generating the traffic light data includes:
implementing operations that match one or more portions of the layout data to the image data, and wherein the traffic light data is based on the one or more matched portions of the layout data and the image data.

19. The tangible, non-transitory computer readable medium of claim 15, wherein the prompt data further identifies the first traffic light as a primary traffic light, the primary traffic light being a traffic light that most likely affects the one or more operations of the AV.

20. The tangible, non-transitory computer readable medium of claim 15, wherein the at least one processor performs operations further comprising:
determining whether the first traffic light is a primary traffic light with respect to the AV based on navigation data of the AV.
